(19) United States
(12) Patent Application Publication
(10) Pub. No.: US 2009/0037926 A1
(43) Pub. Date: Feb. 5, 2009

(54) METHODS AND SYSTEMS FOR TIME-SHARING PARALLEL APPLICATIONS WITH PERFORMANCE ISOLATION AND CONTROL THROUGH PERFORMANCE-TARGETED FEEDBACK-CONTROLLED REAL-TIME SCHEDULING

(76) Inventors: Peter Dinda, Evanston, IL (US); Ananth Sundararaj, Redmond, WA (US); Bin Lin, Hillsboro, OR (US)

Correspondence Address: MCANDREWS HELD & MALLOY, LTD, 500 WEST MADISON STREET, SUITE 3400, CHICAGO, IL, 60661, US

(21) Appl. No.: 11/832,142

(22) Filed: Aug. 1, 2007

(51) Int. Cl. G06F 9/46

(52) U.S. Cl. 718/107

(57) ABSTRACT

Certain embodiments of the present invention provide systems and method for time-sharing parallel applications with performance isolation and control through feedback-controlled real-time scheduling. Certain embodiments provide a computing system for time-sharing parallel applications. The system includes a controller adapted to determine a scheduling constraint for each thread of execution for an application based at least in part on a target execution rate for the application. The system also includes a local scheduler executing on a node in the computing system. The local scheduler schedules execution of a thread of execution for the application based on the scheduling constraint received from the controller. The local scheduler provides feedback regarding a current execution rate for the application thread to the controller, and the controller modifies the scheduling constraint for the local scheduler based on the feedback.

### FEDERALLY SPONSORED RESEARCH OR DEVELOPMENT

The United States government has certain rights to this invention pursuant to Grant Nos. ANI 0301108 and EIA-0224449 from the National Science Foundation to Northwestern University.

### BACKGROUND OF THE INVENTION

The present invention generally relates to time-shared scheduling of parallel applications. More particularly, the present invention relates to methods and systems providing time-sharing for parallel applications with performance isolation and control through performance-targeted, feedback-controlled real-time scheduling.

Grid computing uses multiple sites with different network management and security philosophies, often spread over the wide area. Running a virtual machine on a remote site is equivalent to visiting the site and connecting to a new machine. The nature of the network presence (e.g., active Ethernet port, traffic not blocked, mutable Internet Protocol (IP) address, forwarding of its packets through firewalls, etc.) the machine gets, or whether the machine gets a network presence at all, depends upon the policy of the site. Not all connections between machines are possible and not all paths through the network are free. The impact of this variation is further exacerbated as the number of sites is increased, and if virtual machines are permitted to migrate from site to site.

Virtual machines can greatly simplify grid and distributed computing by lowering the level of abstraction from traditional units of work, such as jobs, processes, or remote procedure calls (RPCs) to that of a raw machine. This abstraction makes resource management easier from the perspective of resource providers and results in lower complexity and greater flexibility for resource users. A virtual machine image that includes preinstalled versions of the correct operating system, libraries, middleware and applications can simplify deployment of new software.

Clusters, grids, and other parallel computing resources require careful scheduling of parallel applications in order to achieve high performance for individual applications and high utilization of resources. To avoid stalls and provide predictable application performance, most tightly-coupled computing resources today are space-shared in order to isolate batch parallel applications from each other and optimize their performance. In space-sharing, each parallel application is given a partition of the available nodes, and on its partition, it is the only application running, providing complete performance isolation between running applications. Space-sharing introduces several problems, however. Most obviously, it limits the utilization of the machine because the CPUs of the nodes are idle when communication or I/O is occurring. Space-sharing also makes it likely that applications that require many nodes will be stuck in a queue for a long time and, when running, block many applications that require small numbers of nodes. Finally, space-sharing permits a provider to control the response time or execution rate of a parallel job at only a very course granularity.

In contrast, time-sharing, where multiple applications may run on a node concurrently, offers potential for much greater utilization of the resource, shorter queue times, and fine grain control of execution rate and response time. However, because applications are not well isolated, time sharing can result in stalls and unpredictable performance that worsens as the application scales across more nodes.

### BRIEF SUMMARY OF THE INVENTION

Certain embodiments of the present invention provide systems and method for time-sharing parallel applications with performance isolation and control through feedback-controlled real-time scheduling.

Certain embodiments provide a computing system for time-sharing parallel applications. The system includes a controller adapted to determine a scheduling constraint for each thread of execution for an application based at least in part on a target execution rate for the application. The system also includes a local scheduler executing on a node in the computing system. The local scheduler schedules execution of a thread of execution for the application based on the scheduling constraint received from the controller. The application or an agent of the application provides feedback regarding a current execution rate for the application thread to the controller, and the controller modifies the scheduling constraint for the local scheduler based on the feedback.

Certain embodiments provide a method for parallel application scheduling using time-sharing. The method includes identifying a target execution rate for an application. The method also includes determining a scheduling constraint for each of the application's threads of execution based at least in part on the target execution rate. Additionally, the method includes providing the scheduling constraint for an application thread of execution to a local scheduler for the application thread of execution. Further, the method includes supplying feedback regarding a current execution rate for the application thread of execution. In addition, the method includes modifying the scheduling constraint for the local scheduler based on the feedback.

Certain embodiments provide one or more computer readable mediums having one or more sets of instructions for execution on one or more computing devices. The one or more sets of instructions include a central controller routine adapted to determine a scheduling constraint for each thread of execution for an application based at least in part on a target execution rate for the application. The one or more sets of instructions also include a local scheduler routine executing on a node in the one or more computing devices. The local scheduler routine schedules execution of a thread of execution for the application based on the scheduling constraint received from the central controller routine. The local scheduler routine provides feedback regarding a current execution rate for the application thread to the central controller routine, and the central controller routine modifies the scheduling constraint for the local scheduler routine based on the feedback.

### BRIEF DESCRIPTION OF SEVERAL VIEWS OF THE DRAWINGS

FIG. 1 illustrates a virtual scheduling system according to an embodiment of the present invention.

FIG. 2 illustrates a control system including a centralized feedback controller and multiple host nodes running a local scheduler according to an embodiment of the present invention.

FIG. 3 illustrates a flow diagram for a method for time-shared parallel scheduling according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide time-sharing of parallel applications on tightly-coupled computing resources. Certain embodiments provide performance-targeted and feedback-controlled real-time scheduling. Certain embodiments provide performance isolation within a time-sharing framework that permits multiple applications to share a node and performance control that allows an administrator to finely control an execution rate of each application while keeping its resource utilization proportional to execution rate. Conversely, in certain embodiments, the administrator can set a target resource utilization for each application and have commensurate application execution rates follow.

In performance-targeted, feedback-controlled, real-time scheduling, each node has a periodic realtime scheduler. A local application thread is scheduled with a constraint (e.g., a (period, slice) constraint), meaning that the application thread executes for slice seconds every period. In certain embodiments, slice/period describes a utilization of an application on a node. In certain embodiments, a virtual scheduler, VSched, and/or other local scheduler providing a periodic real-time model, may be used for application scheduling. The scheduler need not provide hard real-time guarantees, for example. Certain embodiments of the virtual scheduler VSched are further described in B. Lin, and P. Dinda, VSched: Mixing Batch and Interactive Virtual Machines Using Periodic Real-time Scheduling, Proceedings of ACM/IEEE SC 2005 (Supercomputing), November, 2005, and U.S. patent application Ser. No. 11/782,486, filed on Jul. 24, 2007, which are herein incorporated by reference in their entirety.

Once an administrator has set a target execution rate for an application, a global and/or other controller determines an appropriate constraint for each of an application's threads of execution and then contacts each corresponding local scheduler to set the constraint. Controller input includes a desired application execution rate, given as a percentage of the application's maximum rate on the computing system (i.e., as if the application were on a space-shared system). The application or its agent periodically provides feedback to the controller regarding its current execution rate. The controller modifies the local scheduler's constraints based on an error between a desired and actual execution rate, with an added constraint that utilization is proportional to the desired or target execution rate.

In an embodiment, communication in the system may often be minimal except for feedback of regarding the current execution rate of the application to the global controller, and synchronization of the local schedulers through the controller may be infrequent, for example. Applications may be scheduled with greater scalability and execution rates of all applications in the system may be controlled, for example. In certain embodiments, a central processing unit (CPU) of a node is scheduled. In other embodiments, a CPU, as well as physical memory, communication hardware and/or local disk input/output, for example, may be scheduled for a node. In certain embodiments, for example, a node operating system or virtual machine monitor may isolate physical memory for particular application execution. In certain embodiments, by throttling a CPU, communication resources for a node may also be throttled. Disk input/output may also be adjusted to control application execution, for example.

Thus, certain embodiments provide a self-adaptive approach to time-sharing of machines that provides isolation and allows an execution rate of an application to be tightly controlled by an administrator. Certain embodiments combine a periodic real-time scheduler on each node with a global feedback-based control system that governs local schedulers. In certain embodiments, an online system may be used to implement such a system and scheduling approach. In certain embodiments, the system takes as input a target execution rate for each application, and automatically and continuously adjusts the applications' real-time schedules to achieve those rates with proportional CPU utilization. Target rates can be dynamically adjusted, for example. Applications may be performance-isolated from each other and from other work that is not using the system. In certain embodiments, the system may be configured to maintain stable operation with low response times, and a focus on CPU isolation and control may be configured without a significant expense of network I/O, disk I/O, and/or memory isolation, for example.

Tightly-coupled computing resources such as machine clusters may be used to run batch parallel workloads, for example. An application in such a workload may be communication intensive, for example, executing synchronizing collective communication. A Bulk Synchronous Parallel (BSP) model may be used to understand many of these applications. In the BSP model, application execution may alternate between phases of local computation and phases of global collective communication. Because the communication is global, threads of execution on different nodes may be carefully scheduled if the machine is time-shared, for example. If a thread on one node is slow or blocked due to some other thread unrelated to the application, all of the application's threads may stall.

To avoid stalls and provide predictable performance for users, tightly-coupled computing resources today may be space-shared. In space-sharing, each application is given a partition of the available nodes, and on its partition, it is the only application running, thus avoiding the problem altogether by providing complete performance isolation between running applications. Space-sharing, however, may limit utilization of a machine because CPUs of machine nodes may be idle when communication or I/O is occurring. Additionally, with space-sharing, applications that require many nodes may be stuck in the queue for a long time and, when running, block many applications that require small numbers of nodes. Finally, space-sharing permits a provider to control the response time or execution rate of a parallel job at only a very course granularity. Certain embodiments provide a new self-adaptive approach to time-sharing parallel applications on tightly-coupled computing resources such as clusters with performance-targeted, feedback-controlled, real-time scheduling. Certain embodiments provide performance isolation within a time-sharing framework that permits multiple applications to share a node, and performance control that allows an administrator to finely control an execution rate of each application while keeping its resource utilization automatically proportional to execution rate, for example.

Certain embodiments may be applied to schedule parallel applications. Certain embodiments may be applied to a grid computing environment, a system of virtual machines, etc. Certain embodiments may be applied to gang scheduling, implicit co-scheduling, real-time schedulers, and feedback control real-time scheduling, for example. Certain embodiments involve external control of resource use (by a cluster administrator, for example) while maintaining commensurate application execution rates. That is, for example, administrator and user concerns may be reconciled.

A goal of gang scheduling is to “fix” application blocking problems produced by blindly using time-sharing local node schedulers. In gang scheduling, fine-grain scheduling decisions are made collectively over a whole cluster. For example, all of an application's threads may be scheduled at identical times on different nodes, thus giving many of the benefits of space-sharing. However, multiple applications are still permitted to execute together to drive up utilization and thus allow jobs into the system faster. Such gang scheduling provides performance isolation, while performance control may depend on scheduler model. However, gang scheduling may include significant costs in terms of communication to keep node schedulers synchronized, a problem that may be exacerbated by finer grain parallelism and higher latency communication. In addition, code written to simultaneously schedule all tasks of each gang can be complex and involve elaborate bookkeeping and global system knowledge, for example.

Implicit co-scheduling attempts to achieve many of the benefits of gang scheduling without scheduler-specific communication. With implicit co-scheduling, communication irregularities, such as blocked sends or receives, are used to infer a likely state of the remote, uncoupled scheduler, and then to adjust the local scheduler's policies to compensate. However, in addition to complexity inherent in inference and adapting the local communication schedule, implicit co-scheduling may not provide a straightforward way to control effective application execution rate, response time, or resource usage, for example.

In feedback control real-time scheduling, concepts from feedback control theory may be used to develop resource scheduling algorithms to give quality of service guarantees in unpredictable environments to applications such as online trading, agile manufacturing, and web servers. In contrast, certain embodiments use concepts from feedback control theory to manage a tightly controlled environment, targeting parallel applications with collective communication, for example.

Feedback-based control may also be used to provide CPU reservations to application threads running on a single machine based on measurements of their progress. Feedback-based control may be used for controlling coarse-grained CPU utilization in a simulated virtual server, for dynamic database provisioning for web servers, and/or to enforce web server CPU entitlements to control response time, for example.

### Local Scheduler

In a periodic real-time model, a task is run for slice seconds every period seconds. Using earliest deadline first (EDF) schedulability analysis, for example, the scheduler can determine whether some set of (period, slice) constraints can be met. The scheduler then uses dynamic priority preemptive scheduling with the deadlines of admitted tasks as priorities.

VSched or other similar scheduler may provide a user-level implementation of this approach that offers soft real-time guarantees. A scheduler may run as an operating system process, for example, that schedules other processes. The scheduler may run as a Linux process scheduling other Linux processes, for example. The scheduler may support (period, slice) constraints ranging from the low hundreds of microseconds (if certain kernel features are available) to days, for example. Using this range, the needs of various classes of applications can be described and accommodated. The scheduler may be configured to allow changes to a task's constraints substantially in real-time, for example.

In certain embodiments, a scheduler, such as VSched, may be implemented as a client/server system. A VSched server, for example, may be a daemon running on an operating system, such as Linux, that spawns a scheduling core executing a scheduling scheme. A VSched client, for example, communicates with the server over an encrypted data connection, such as a Transmission Control Protocol (TCP) or other connection. In certain embodiments, the client may be driven by a global controller and schedule individual processes, for example.

### Virtual Machine Scheduler (VSched)

In certain embodiments, a virtual machine scheduler (VSched) schedules a collection of virtual machine (VMs) on a host according to a model of independent periodic real-time tasks. Tasks can be introduced or removed from control at any point in time through a client/server interface, for example.

A periodic real-time model may be used as a unifying abstraction that can provide for the needs of the various classes of applications described above. In a periodic realtime model, a task is run for a certain slice of seconds in every period of seconds. The periods may start at time zero, for example. Using an earliest deadline first (EDF) schedulability analysis, the scheduler can determine whether some set of (period, slice) constraints can be met. The scheduler then uses dynamic priority preemptive scheduling based on deadlines of the admitted tasks as priorities.

In certain embodiments, VSched offers soft, rather than hard, real-time guarantees. VSched may accommodate periods and slices ranging from microseconds, milliseconds and on into days, for example. In certain embodiments, a ratio slice/period defines a compute rate of a task. In certain embodiments, a parallel application may be run in a collection of VMs, each of which is scheduled with the same (period, slice) constraint. If each VM is given the same schedule and starting point, then they can run in lock step, avoiding synchronization costs of typical gang scheduling.

In certain embodiments, VSched is a user-level program that runs on an operating system, such as Linux, and schedules other operating system processes. For example, VSched may be used to schedule VMs, such as VMs created by VMware GSX Server. GSX is a type-II virtual machine monitor, meaning that it does not run directly on the hardware, but rather on top of a host operating system (e.g., Linux). A GSX VM, including all of the processes of the guest operating system running inside, appears as a process in Linux, which is then scheduled by VSched.

In accordance with certain embodiments of the present invention, existing, unmodified applications and operating systems run inside of virtual machines (VMs). A VM can be treated as a process within an underlying “host” operating system (such as a type-I1 virtual machine monitor (VMM)) or within the VMM itself (e.g., a type-I VMM). The VMM presents an abstraction of a network adaptor to the operating system running inside of the VM. An overlay network is attached to this virtual adaptor. The overlay network ties the VM to other VMs and to an external network. From a vantage point “under” the VM and VMM, tools can observe the dynamic behavior of the VM, specifically its computational and communications demands, for example.

While type-11 VMMs are the most common on today's hardware, and VSched's design lets it work with processes that are not VMs, periodic real-time scheduling of VMs can also be applied in type-I VMMs. A type-I VMM runs directly on the underlying hardware with no intervening host operating system. In this case, the VMM schedules the VMs it has created just as an operating system would schedule processes. Just as many operating systems support the periodic realtime model, so can type-I VMMs.

In certain embodiments, for example, VSched uses an EDF algorithm schedulability test for admission control and uses EDF scheduling to meet deadlines. In certain embodiments, VSched is a user-level program that uses fixed priorities within, for example, Linux's SCHED_FIFO scheduling class and SIGSTOP/SIGCONT to control other processes, leaving aside some percentage of CPU time for processes that it does not control. By default, VSched is configured to be work-conserving for the real-time processes it manages, allowing them to also share these resources and allowing non real-time processes to consume time when the realtime processes are blocked.

In certain embodiments, VSched includes a parent and a child process that communicate via a shared memory segment and a pipe. As described above, VSched may employ one or more priority algorithms such as the EDF dynamic priority algorithm discussed above. EDF is a preemptive policy in which tasks are prioritized in reverse order of the impending deadlines. The task with the highest priority is the one that is run first. Given a system of n independent periodic tasks, a fast algorithm may be used to determine if the n tasks, scheduled using EDF, will all meet their deadlines:

$$U ( n ) = {\sum }_{k = 1}^{n} \frac{{slice}_{k}}{{period}_{k}} \leq 1 , \qquad ( 1 )$$

where U(n) is the total utilization of the task set being tested.

Three scheduling policies are supported in the current Linux kernel, for example: SCHED_FIFO, SCHED_RR and SCHED_OTHER. SCHED_OTHER is a default universal time-sharing scheduler policy used by most processes. It is a preemptive, dynamic-priority policy. SCHED_FIFO and SCHED_RR are intended for special time-critical applications that need more precise control over the way in which runnable processes are selected for execution. Within each policy, different priorities can be assigned, with SCHED_FIFO priorities being higher than SCHED_RR priorities which are in turn higher than SCHED_OTHER priorities, for example. In certain embodiments, SCHED_FIFO priority 99 is the highest priority in the system, and it is the priority at which the scheduling core of VSched runs. The server front-end of VSched runs at priority 98, for example.

SCHED_FIFO is a simple preemptive scheduling policy without time slicing. For each priority level in SCHED_FIFO, a kernel maintains a FIFO (first-in, first-out) queue of processes. The first runnable process in the highest priority queue with any runnable processes runs until it blocks, at which point the process is placed at the back of its queue. When VSched schedules a VM to run, VSched sets the VM to SCHED_FIFO and assigns the VM a priority of 97, just below that of the VSched server front-end, for example.

In certain embodiments, the following rules are applied by the kernel. A SCHED_FIFO process that has been preempted by another process of higher priority will stay at the head of the list for its priority and will resume execution as soon as all processes of higher priority are blocked again. When a SCHED_FIFO process becomes runnable, it will be inserted at the end of the list for its priority. A system call to sched_setscheduler or sched_setparam will put the SCHED_FIFO process at the end of the list if it is runnable. A SCHED_FIFO process runs until the process is blocked by an input/output request, it is preempted by a higher priority process, or it calls sched_yield.

In certain embodiments, after configuring a process to run at SCHED_FIFO priority 97, the VSched core waits (blocked) for one of two events using a select system call. VSched continues when it is time to change the currently running process (or to run no process) or when the set of tasks has been changed via the front-end, for example.

By using EDF scheduling to determine which process to raise to highest priority, VSched can help assure that all admitted processes meet their deadlines. However, it is possible for a process to consume more than its slice of CPU time. By default, when a process's slice is over, it is demoted to SCHED_OTHER, for example. VSched can optionally limit a VM to exactly the slice that it requested by using the SIGSTOP and SIGCONT signals to suspend and resume the VM, for example.

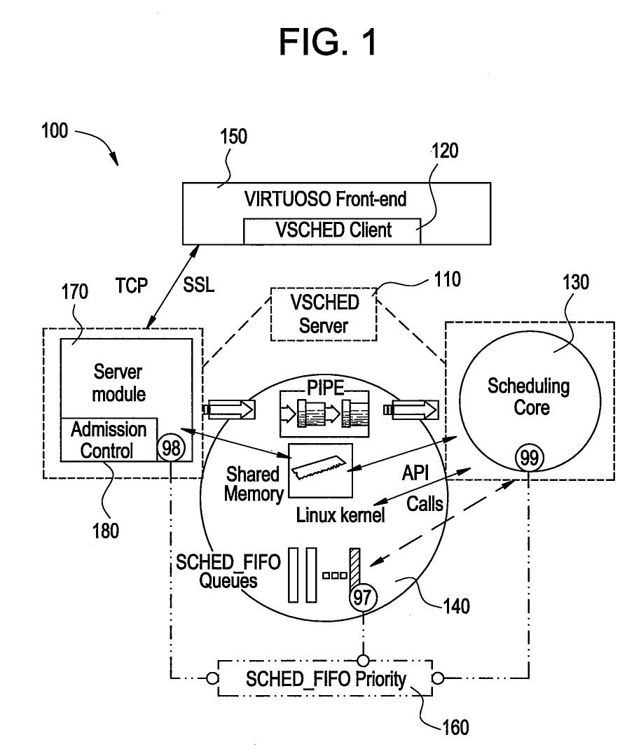

In certain embodiments, VSched 100 includes a server 110 and a client 120, as shown in FIG. 1. The VSched server 110 is a daemon running on, for example, a Linux kernel 140 that spawns the scheduling core 130, which executes the scheduling scheme described above. The VSched client 120 communicates with the server 110 over a TCP or other connection that is encrypted using SSL, for example. Authentication is accomplished by a password exchange, for example. In certain embodiments, the server 110 communicates with the scheduling core 130 through two mechanisms. First, the server 110 and the scheduling core 130 share a memory segment which contains an array that describes the current tasks to be scheduled as well as their constraints. Access to the array may be guarded via a semaphore, for example. The second mechanism is a pipe from server 110 to core 130. The server 110 writes on the pipe to notify the core 130 that the schedule has been changed.

In certain embodiments, using the VSched client 120, a user can connect to the VSched server 110 and request that any process be executed according to a period and slice. Process ids (pids) used by the VMs may be tracked, for example. For example, a specification (3333, 1000 ms, 200 ms) would mean that process 3333 should be run for 200 ms every 1000 ms. In response to such a request, the VSched server 110 determines whether the request is feasible. If it is, the VSched server 110 will add the process to the array and inform the scheduling core 130. In either case, the server 110 replies to the client 120.

VSched allows a remote client to find processes, pause or resume them, specify or modify their real-time schedules, and return them to ordinary scheduling, for example. Any process, not just VMs, can be controlled in this way.

VSched's admission control algorithm is based on Equation 1, the admissibility test of the EDF algorithm. In certain embodiments, a certain percentage of CPU time is reserved for SCHED_OTHER processes. The percentage can be set by the system administrator when starting VSched, for example.

In certain embodiments, the scheduling core is a modified EDF scheduler that dispatches processes in EDF order but interrupts them when they have exhausted their allocated CPU time for the current period. If so configured by the system administrator, VSched may stop the processes at this point, resuming them when their next period begins.

When the scheduling core receives scheduling requests from the server module, it may interrupt the current task and make an immediate scheduling decision based on the new task set, for example. The scheduling request can be a request for scheduling a newly arrived task or for changing a task that has been previously admitted, for example.

Thus, certain embodiments use a periodic real-time model for virtual-machine-based distributed computing. A periodic real-time model allows mixing of batch and interactive VMs, for example, and allows users to succinctly describe their performance demands. The virtual scheduler allows a mix of long-running batch computations with fine-grained interactive applications, for example. VSched also facilitates scheduling of parallel applications, effectively controlling their utilization while limiting adverse performance effects and allowing the scheduler to shield parallel applications from external load. Certain embodiments provide mechanisms for selection of schedules for a variety of VMs, incorporation of direct human input into the scheduling process, and coordination of schedules across multiple machines for parallel applications, for example.

### Global Controller

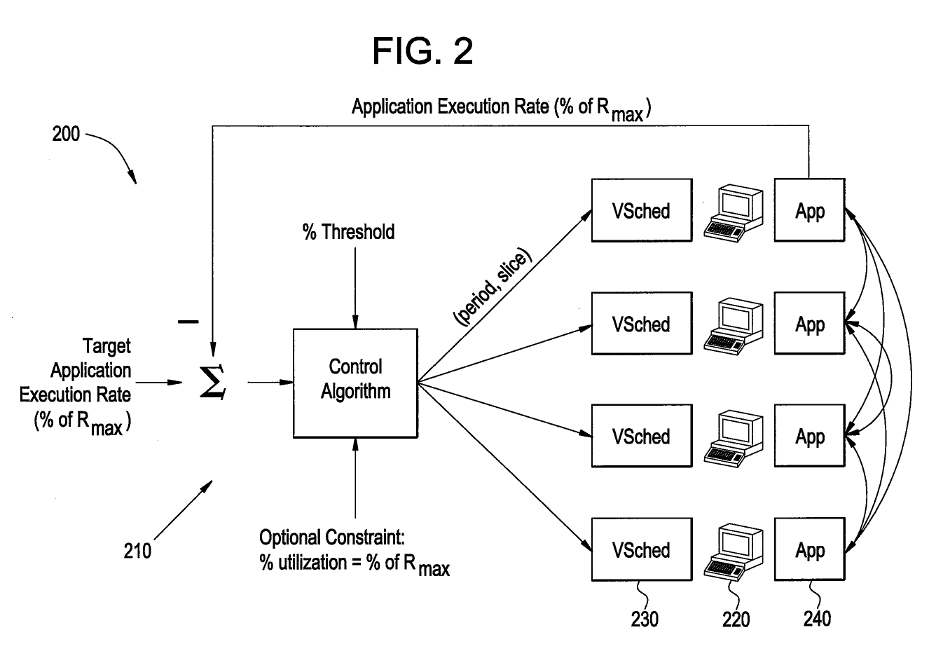

In certain embodiments, a control system 200 includes a centralized feedback controller 210 and multiple host nodes 220, each running a local copy of VSched 230, as shown in FIG. 2. A VSched daemon schedules the local thread(s) of the application(s) 240 under the yoke of the controller 210. The controller 210 sets (period, slice) constraints using the mechanisms described above. In certain embodiments, the same constraint is used for each VSched 230. However, in certain embodiments, different constraints may be applied to different schedulers. In certain embodiments, one thread of the application, or some other agent, periodically communicates with the controller using non-blocking communication, for example.

### Inputs

A maximum application execution rate on the system in application-defined units is defined as Rₘₐₓ. A set point of the controller may be supplied by a user or a system administrator through an interface, such as a command-line interface, that sends a message to the controller. The set point is represented by r_{target} and may be a percentage of Rₘₐₓ, for example. A scheduling system may also be defined by its threshold for error, ε, which is given as a percentage point. Inputs Δ_{slice} and Δ_{period} specify the smallest amounts by which the slice and period can be changed. Inputs min_{slice} and min_{period} define the smallest slice and period that VSched can achieve on the hardware.

A current utilization of an application is defined in terms of its scheduled period and slice, U=slice/period. In certain embodiments, utilization may be proportional to a target execution rate, that is, that r_{target}−ε≦U≦r_{target}+ε.

A feedback input r_{current} comes from a parallel application being scheduled and represents the application's current execution rate as a percentage of Rₘₐₓ. To minimize or reduce modification of the application and communication overhead, certain embodiments involve high-level knowledge of an application's control flow and a few extra lines of code, for example.

### Control Algorithm

A control algorithm may be used to choose a (period, slice) constraint to achieve one or more goals, including one or more of the following goals:

1. An error is within threshold: r_{current}=r_{target}±ε, and

2. A schedule is efficient: U=r_{target}±ε.

The algorithm may be based on intuition and an observation that application performance may vary depending on which of the many possible (period, slice) schedules corresponding to a given utilization U are chosen. A best choice may be application dependent and vary with time. For example, a finer grain schedule (e.g. (20 ms, 10 ms)) may result in better application performance than coarser grain schedules (e.g., (200 ms, 100 ms)). At any point in time, there may be multiple “best” schedules.

The control algorithm attempts to automatically and dynamically achieve goals 1 and 2 in the above, maintaining a particular execution rate r_{target} specified by the user while keeping utilization proportional to the target rate, for example.

Error may be defined as e=r_{current}−r_{target}.

At startup, the algorithm is given an initial rate r_{target}. The algorithm chooses a (period, slice) constraint such that U=r_{target}, and period is set to a relatively large value such as 200 ms. The algorithm involves a linear search for the largest period that satisfies specified criteria.

When the application reports a new current rate measurement r_{current} and/or the user specifies a change in the target rate r_{target}, e is recomputed, followed by:

1. If |e|>ε decrease period by Δ_{period} and decrease slice by Δ_{slice} such that slice/period=U=r_{target}. If period≦min_{period}) then period is rest to the previous value and again set slice such that U=r_{target}.

2. If |e|≦ε, then do nothing.

In certain embodiments, the algorithm maintains the target utilization and searches the (period, slice) space from larger to smaller granularity, subject to the utilization constraint. The linear search is, in part, done because multiple appropriate schedules may exist. In alternative embodiments, other algorithms that walk the space faster may be used.

In certain embodiments, (period, slice) schedules are determined which provide an application execution rate with proportional utilization. In other embodiments, (period, slice) schedules may be implemented without proportional utilization.

In certain embodiments, with proportional utilization, a (period, slice) schedule may be automatically selected for an application based on information such as compute/communicate ratios, granularities, and communication patterns for the particular application. In certain embodiments, a user and/or administrator may dynamically change the application execution rate r_{target}, and the scheduler may react automatically. In certain embodiments, deadline misses may occur, resulting in timing offsets between different application threads. The timing offsets may accumulate. In certain embodiments, deadline misses may be monitored and corrected using a soft local real-time scheduler, for example.

In certain embodiments, scheduling may be evaluated based on one or more performance metrics, including minimum threshold and response time, for example. A minimum threshold identifies the smallest ε below which control becomes unstable. A response time indicates, for a stable configuration, what is the typical time between when the target execution rate r_{target} changes and when r_{target}=r_{target}±ε. In certain embodiments, when the error threshold ε is too small, the controller may become unstable and may fail because the change applied by the control system to correct the error is greater than the error itself.

### Dynamic Target Execution Rates

In certain embodiments, using a feedback control mechanism, target execution rates may be dynamically changed and the control system may continuously adjust the real-time schedule to adapt to the changes. Any coupled parallel program can suffer from external load on any node because the program runs at the speed of the slowest node. A periodic, real-time scheduler model can shield the program from such external load, helping to prevent a slowdown. Additionally, a control system as a whole, as described herein, can help protect a BSP application from external load, for example.

Certain embodiments provide a system in which the global controller is given the freedom to set a different schedule on each node, thus making the control system more flexible. The system can provide time-sharing for multiple parallel applications, for example.

Thus, certain embodiments provide a new self-adaptive approach to time-sharing parallel applications on tightly coupled compute resources, such as clusters. Performance-targeted, feedback-controlled, real-time scheduling is based on a combination of local scheduling using a periodic real-time model and a global feedback control system that sets local schedules. Certain embodiments provide performance-isolate parallel applications and allow administrators to dynamically change a desired application execution rate while keeping actual CPU utilization automatically proportional to the application execution rate. Certain embodiments include a user-level scheduler, such as a user-level Linux or other operating system scheduler, and a centralized controller. Certain embodiments may also be applied to other workloads, such as web applications, having complex communication and synchronization behavior, and high-performance parallel scientific applications having performance requirements which are typically not know a priori and change as the applications proceed. In certain embodiments, direct feedback from an end user may be utilized in the scheduling system.

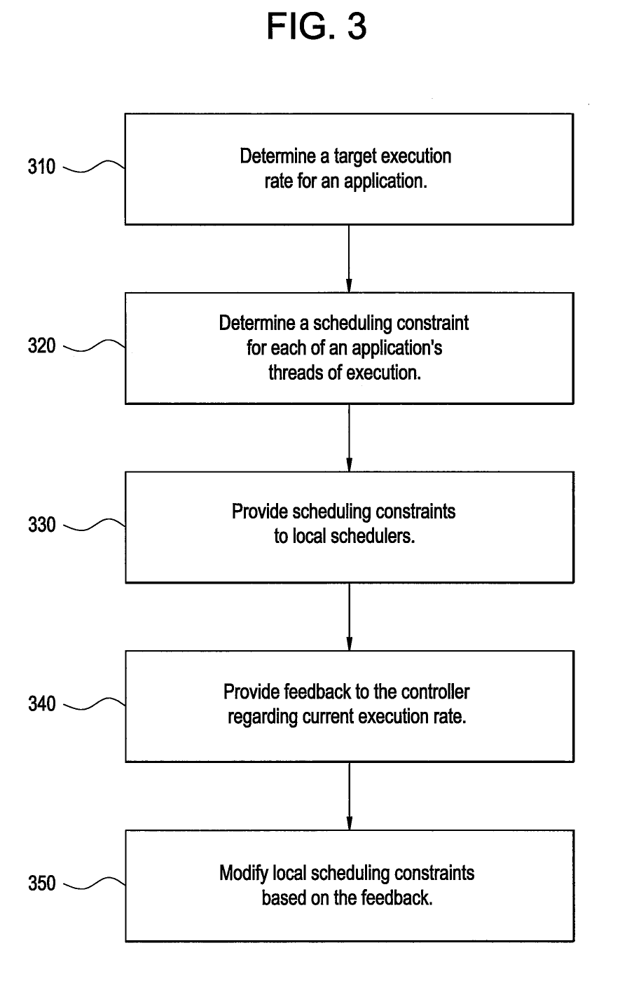

FIG. 3 illustrates a flow diagram for a method 300 for performance improvement in a virtual network according to an embodiment of the present invention. First, at step 310, a target execution rate for an application is determined. For example, a user or administrator provides a target execution rate for an application. As another example, a target execution rate for an application may be determined based on benchmark data, system parameters, etc.

At step 320, a controller determines a scheduling constraint for each of an application's threads of execution. For example, a global controller uses the target execution rate for the application, computing system parameters, a number of threads for the application, etc., to determine a scheduling constraint for each application thread. In certain embodiments, all threads have the same constraint (e.g., a (period, slice) constraint). In other embodiments, different threads may have different constraints.

At step 330, corresponding local schedulers are given the scheduling constraints. For example, controller input to a local scheduler may include a desired application execution rate given as a percentage of the application's maximum rate on the system.

At step 340, feedback is provided from the application or its agent to the controller regarding current execution rate. At step 350, the controller modifies the local scheduler's constraints based on a difference between reported and target execution rate for the application and/or for an application thread, for example. In certain embodiments, local scheduling constraints may be modified based on the difference limited by a proportionality between time utilization and the target execution rate.

One or more of the steps of the method 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Application of certain embodiments of a performance isolation and control scheduling system, as described herein, may be found in Bin Lin, Ananth I. Sundararaj and Peter A. Dinda, Time-sharing Parallel Applications With Performance Isolation and Control, Technical Report NWU-EECS-06-10, Department of Electrical Engineering & Computer Science, Northwestern University, Jan. 11, 2007, and B. Lin, A. Sundararaj, P. Dinda, Time-sharing Parallel Applications With Performance Isolation And Control, Proceedings of the 4th IEEE International Conference on Autonomic Computing (ICAC 2007), June, 2007, which are herein incorporated by reference in their entirety.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any parallel or distributed computing system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A computing system for time-sharing parallel applications, said system comprising:
a controller adapted to determine a scheduling constraint for each thread of execution for an application based at least in part on a target execution rate for the application; and
a local scheduler executing on a node in the computing system, the local scheduler scheduling execution of a thread of execution for the application based on the scheduling constraint received from the controller,
wherein the local scheduler provides feedback regarding a current execution rate for the application thread to the controller and wherein the controller modifies the scheduling constraint for the local scheduler based on the feedback.

2. The system of claim 1, wherein the local scheduler provides a periodic, real-time model for scheduling the thread of execution for the application based on the scheduling constraint.

3. The system of claim 1, wherein the scheduling constraint comprises a (period, slice) constraint.

4. The system of claim 1, wherein all threads of execution for the application have the same scheduling constraint.

5. The system of claim 1, wherein the controller modifies the scheduling constraint for the local scheduler based on a difference between the current execution rate and the target execution rate.

6. The system of claim 1, wherein the controller modifies the scheduling constraint based on a proportionality between node resource utilization and the target execution rate.

7. The system of claim 1, wherein the target execution rate is specified by a user or system administrator.

8. The system of claim 1, wherein the target execution rate is dynamically adjusted during execution of the application.

9. The system of claim 1, further comprising a plurality of local schedulers executing on a plurality of nodes to accommodate execution of a plurality of applications in parallel under control of the controller.

10. The system of claim 9, wherein the plurality of applications are performance isolated from each other.

11. A method for parallel application scheduling using time-sharing, said method comprising:
identifying a target execution rate for an application;
determining a scheduling constraint for each of the application's threads of execution based at least in part on the target execution rate;
providing the scheduling constraint for an application thread of execution to a local scheduler for the application thread of execution;
supplying feedback regarding a current execution rate for the application thread of execution; and
modifying the scheduling constraint for the local scheduler based on the feedback.

12. The method of claim 11, wherein the target execution rate is specified by a user or system administrator.

13. The method of claim 11, wherein said determining step further comprises determining the scheduling constraint for the application thread of execution based on the target execution rate for the application, a number of threads for the application and system parameters.

14. The method of claim 11, wherein all threads of execution for the application have the same scheduling constraint.

15. The method of claim 11, wherein the scheduling constraint comprises a (period, slice) constraint.

16. The method of claim 11, wherein said modifying step further comprises modifying the scheduling constraint for the local scheduler based on a difference between the current execution rate and the target execution rate.

17. The method of claim 11, wherein said modifying step further comprises modifying the scheduling constraint based on a proportionality between resource utilization and the target execution rate.

18. One or more computer readable mediums having one or more sets of instructions for execution on one or more computing devices, said one or more sets of instructions comprising:
a central controller routine adapted to determine a scheduling constraint for each thread of execution for an application based at least in part on a target execution rate for the application; and
a local scheduler routine executing on a node in the one or more computing devices, the local scheduler routine scheduling execution of a thread of execution for the application based on the scheduling constraint received from the central controller routine,
wherein the local scheduler routine provides feedback regarding a current execution rate for the application thread to the central controller routine and wherein the central controller routine modifies the scheduling constraint for the local scheduler routine based on the feedback.

19. The one or more computer readable media of claim 18, wherein the scheduling constraint comprises a (period, slice) constraint.

20. The one or more computer readable media of claim 18, wherein the central controller routine modifies the scheduling constraint for the local scheduler routine based on a difference between the current execution rate and the target execution rate.

21. The one or more computer readable media of claim 18, wherein the central controller routine modifies the scheduling constraint based on a proportionality between computing resource utilization and the target execution rate.
